(19) United States
(12) Patent Application Publication
(10) Pub. No.: US 2025/0220612 A1
(43) Pub. Date: Jul. 3, 2025

(54) UPDATING INFORMATION FOR UPLINK SYNCHRONIZATION

(71) Applicant: Nokia Technologies Oy, Espoo (FI)

(72) Inventors: Pingping WEN, Shanghai (CN); Ping YUAN, Beijing (CN)

(21) Appl. No.: 18/998,171

(22) PCT Filed: Jul. 29, 2022
(86) PCT No.: PCT/CN2022/109271

§ 371 Date: Jan. 24, 2025

(51) Int. Cl. H04W 56/00; H04B 7/185

(52) U.S. Cl. CPC H04W 56/0045; H04B 7/1851

(57) ABSTRACT

Example embodiments of the present disclosure relate to a terminal device, a network device, methods, apparatuses and a computer readable storage medium for updating information for uplink synchronization. The terminal device determines a first threshold duration for first information for uplink synchronization and a second threshold duration for second information for the uplink synchronization; and performs a first procedure for updating the first information and a second procedure for updating the second information based on: determining that a validity duration of one piece of information expires and a remaining validity duration of the other piece of information is shorter than corresponding threshold duration. As such, the two procedures updating the first information and the second information may be aligned with each other, thus the complexity can be reduced, the power consumption can be reduced, and the communication efficiency may be improved.

### FIELD

Example embodiments of the present disclosure generally relate to the field of telecommunication and in particular, to a terminal device, a network device, methods, apparatuses and a computer readable storage medium for a solution of updating information for uplink synchronization.

### BACKGROUND

In a non-terrestrial network (NTN), global navigation satellite system (GNSS) information and satellite ephemeris information are two pieces of important information for synchronization of a terminal device, such as a user equipment (UE). From power saving point of view, a UE does not need to obtain the GNSS or ephemeris information frequently. Therefore in Release 17, it is agreed that validity of GNSS and ephemeris information could last for validity durations separately. As such, the UE can assume that the GNSS information and the ephemeris information are valid and may be utilized for synchronization if both timers for the validity durations are not expired.

When one of various pieces of information for uplink synchronization, for example, the GNSS information or the ephemeris information becomes invalid due to, for example, expiry of corresponding validity duration, the UE may need to update the information before the UE can perform the uplink synchronization. However, the manner in which the UE updates various pieces of information for uplink synchronization can be improved and optimized.

### SUMMARY

In general, example embodiments of the present disclosure provide a solution for updating information for uplink synchronization.

In a first aspect, there is provided a terminal device. The terminal device comprises at least one processor and at least one memory storing instructions that, when executed by the at least one processor, cause the terminal device at least to: determine a first threshold duration for a remaining validity duration of first information for uplink synchronization and a second threshold duration for a remaining validity duration of second information for the uplink synchronization; and perform a first procedure for updating the first information and a second procedure for updating the second information based on at least one of: determining that a validity duration of the first information expires and a remaining validity duration of the second information is shorter than the second threshold duration, or determining that a validity duration of the second information expires and a remaining validity duration of the first information is shorter than the first threshold duration.

In a second aspect, there is provided a network device. The network device comprises at least one processor and at least one memory storing instructions that, when executed by the at least one processor, cause the network device at least to: determine a first threshold duration for a remaining validity duration of first information for uplink synchronization associated with a terminal device; determine a second threshold duration for a remaining validity duration of second information for the uplink synchronization; and transmit, to the terminal device, the first threshold duration and the second threshold duration.

In a third aspect, there is provided a method performed by a terminal device. The method comprises: determining, at a terminal device, a first threshold duration for a remaining validity duration of first information for uplink synchronization and a second threshold duration for a remaining validity duration of second information for the uplink synchronization; and performing a first procedure for updating the first information and a second procedure for updating the second information based on at least one of: determining that a validity duration of the first information expires and a remaining validity duration of the second information is shorter than the second threshold duration, or determining that a validity duration of the second information expires and a remaining validity duration of the first information is shorter than the first threshold duration.

In a fourth aspect, there is provided a method performed by a network device. The method comprises: determining, at a network device, a first threshold duration for a remaining validity duration of first information for uplink synchronization associated with a terminal device; determining a second threshold duration for a remaining validity duration of second information for the uplink synchronization; and transmitting, to the terminal device, the first threshold duration and the second threshold duration.

In a fifth aspect, there is provided an apparatus. The apparatus comprises: means for determining, at a terminal device, a first threshold duration for a remaining validity duration of first information for uplink synchronization and a second threshold duration for a remaining validity duration of second information for the uplink synchronization; and means for performing a first procedure for updating the first information and a second procedure for updating the second information based on at least one of: determining that a validity duration of the first information expires and a remaining validity duration of the second information is shorter than the second threshold duration, or determining that a validity duration of the second information expires and a remaining validity duration of the first information is shorter than the first threshold duration.

In a sixth aspect, there is provided an apparatus. The apparatus comprises: means for determining, at a network device, a first threshold duration for a remaining validity duration of first information for uplink synchronization associated with a terminal device; means for determining a second threshold duration for a remaining validity duration of second information for the uplink synchronization; and means for transmitting, to the terminal device, the first threshold duration and the second threshold duration.

In a seventh aspect, there is provided a non-transitory computer readable medium comprising program instructions for causing an apparatus to perform at least the method in the third or fourth aspect.

In an eighth aspect, there is provided a computer program comprising instructions, which, when executed by an apparatus, cause the apparatus at least to perform the method in the third or fourth aspect.

In a ninth aspect, there is provided a terminal device. The terminal device comprises: determining circuitry configured to determine a first threshold duration for a remaining validity duration of first information for uplink synchronization and a second threshold duration for a remaining validity duration of second information for the uplink synchronization; and performing circuitry configured to perform a first procedure for updating the first information and a second procedure for updating the second information based on at least one of: determining that a validity duration of the first information expires and a remaining validity duration of the second information is shorter than the second threshold duration, or determining that a validity duration of the second information expires and a remaining validity duration of the first information is shorter than the first threshold duration.

In a tenth aspect, there is provided a network device. The network device comprises: determining circuitry configured to determine a first threshold duration for a remaining validity duration of first information for uplink synchronization associated with a terminal device; determining circuitry configured to determine a second threshold duration for a remaining validity duration of second information for the uplink synchronization; and transmitting circuitry configured to transmit, to the terminal device, the first threshold duration and the second threshold duration.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of a network environment in which some example embodiments of the present disclosure may be implemented;

FIGS. 1B-1C illustrate other examples of a network environment in which some example embodiments of the present disclosure may be implemented;

FIG. 2 illustrates an example of a process flow in accordance with some example embodiments of the present disclosure;

FIG. 3 illustrates an example timing graph with GNSS information expiry in accordance with some example embodiments of the present disclosure;

FIG. 4 illustrates an example of timing graph with ephemeris information expiry in accordance with some example embodiments of the present disclosure;

FIG. 5 illustrates a flowchart of a method implemented at a terminal device in accordance with some example embodiments of the present disclosure;

FIG. 6 illustrates a flowchart of a method implemented at a network device in accordance with some example embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), enhanced Machine-Type Communication (eMTC), Non-terrestrial network (NTN), IoT over NTN, and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the present disclosure, the term “GNSS information” may be used interchangeable with GNSS position information, GNSS position fix, GNSS fix, GNSS fix information, GNSS or the like. In some embodiments, the GNSS information may be acquired by a terminal device, such as an IoT device, by a measurement. For example, the terminal device may perform a GNSS fix measurement to acquire the GNSS position information.

In the present disclosure, the term “ephemeris information” may be used interchangeable with ephemeris data, ephemeris data information, satellite ephemeris or the like. In some embodiments, the ephemeris information may be obtained by a terminal device, such as an IoT device, by reading system information block (SIB). For example, the terminal device may perform a SIB reading (or ephemeris information reading) to obtain the ephemeris information.

As discussed above, the GNSS positon information and ephemeris information may be important in NTN for a UE. It is proposed to study narrow band internet of things (NB-IoT) or enhanced MTC (eMTC) support for NTN in release 17. GNSS and ephemeris information are important information for UE uplink synchronization. The accuracy of the GNSS and ephemeris information will directly impact on the accuracy of the synchronization. In release 17, the work was limited to short and sporadic connection.

In 3GPP radio access network group 1 (RAN1) and radio access network group 2 (RAN2), for example, there are the following agreements:
For sporadic short transmission:
   The idle UE wakes up from idle discontinuous reception (DRX)/power saving mode (PSM), access the network, perform uplink and/or downlink communications for a short duration of time and go back to idle.
   Before accessing the network, the UE acquires GNSS position fix and does not need to re-acquire a GNSS position fix for the transmission of the packets.
For sporadic short transmission, UE in radio resource control connected mode (RRC_CONNECTED) should go back to idle mode and re-acquire a GNSS position fix if GNSS becomes outdated.

The following agreements are considered to specify the aspects related to GNSS position validity:
For sporadic short transmission, UE in RRC_CONNECTED should go back to idle mode and re-acquire a GNSS position fix if GNSS becomes outdated
The UE autonomously determines its GNSS validity duration X and reports information associated with this valid duration to the network via RRC signaling.
X={10 s, 20 s, 30 s, 40 s, 50 s, 60 s, 5 min, 10 min, 15 min, 20 min, 25 min, 30 min, 60 min, 90 min, 120 min, infinity}.
Note: The duration of the short transmission is not longer than the “validity timer for UL synchronization” referred to in the WID objective (but which still needs further discussion for specifying further details).
The serving satellite ephemeris and common time advance (TA) related parameters are signalled in the same SIB message and have the same epoch time.
A single validity duration for both serving satellite ephemeris and common TA related parameters is broadcast on the SIB.
NTN validity duration is configured per cell and indicated to the UE in X bits with a value range of {5, 10, 15, 20, 25, 30, 35, 40, 45, 50, 55, 60, 120, 180, 240, Infinity} which has a unit “second”.
UE needs to have a valid GNSS fix before going to connected. It is assumed that the UE may need to re-acquire the GNSS fix right before establishing the connection (regardless if previously valid or not), if needed to avoid interruption during the connection.
when the GNSS fix becomes outdated in RRC_CONNECTED mode, the UE goes to IDLE mode.

It is proposed to further study IoT-NTN performance enhancement in release 18. In release 18, improved GNSS operations for a new position fix for UE pre-compensation during long connection times and for reduced consumption should be studied. However, due to simultaneous GNSS and IoT NTN operation is not assumed and the IoT devices are half-duplex, there are limitations on when the UE (such as an IoT device) can acquire GNSS and read ephemeris information as well as the uplink/downlink (UL/DL) transmission and scheduling. For example, it is needed to avoid UL/DL transmission colliding with GNSS acquisition, or avoid UL transmission colliding with SIB reading for satellite ephemeris data.

If the GNSS fix or ephemeris information is outdated, the UE will be considered to loss the synchronization and the uplink transmission cannot be scheduled or continued. Moreover, the serving time of one satellite is limited due to the movement of the satellite, thus the UE should make use of the limited serving time to finish the UL/DL transmission. In this regard, it is important to improve the GNSS and ephemeris information operations to reduce the impact on UL/DL transmission and scheduling.

In RAN1, it is proposed that the measurement gap could be used for GNSS measurement, which should be supported for long data connections. In RAN2, it was agreed that when the ephemeris information used for UL synchronization (pre-compensation) is no longer valid, the UE autonomously tunes away and re-acquires the ephemeris information, and then comes back.

It is noted that the network side needs to consider the measurement gap(s) in scheduling during the GNSS and/or ephemeris (re) acquisition. Since the GNSS and ephemeris (re) acquisition are performed in two gaps separately, the network side needs to accommodate two gaps independently. For example, the gap may have impact on link adaptation, i.e., the radio failure (RF) condition of the channels which will impact the modulation coding scheme (MCS) determination. For example, the gap may bring more complexity in scheduling, e.g., considering whether the gap should be included for the repetition and data transmission interruption. For example, the gap may result in DL/UL switching for each of the gap. Therefore, the handling of two gaps is complex during scheduling and data transmission interruption.

More generally, the above technical problems identified and described with regard to the GNSS information and the ephemeris information may also exist in a similar scenario in which any two or more types of information for uplink synchronization are considered. In other words, there may be two different information, such as first information and second information, for uplink synchronization. The acquisitions of the first information and the second information may be separated, and the validity durations for the first information and the second information may be different. In this event, updating the first information and the second information separately may result in high complexity and more power consumption.

Example embodiments of the present disclosure provide a solution for updating information for uplink synchronization. Especially, a terminal device may update both first information and second information, if one is expired and the remaining duration of the other one is shorter than a threshold. As such, the two procedures updating the first information and the second information may be aligned with each other. In this event, there is only one gap for updating even during scheduling and data transmission interruption. Thus, the complexity can be reduced, the power consumption can be reduced, and the communication efficiency may be improved. Principles and some example embodiments of the present disclosure will be described in detail below with reference to the accompanying drawings.

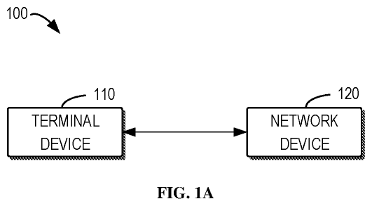

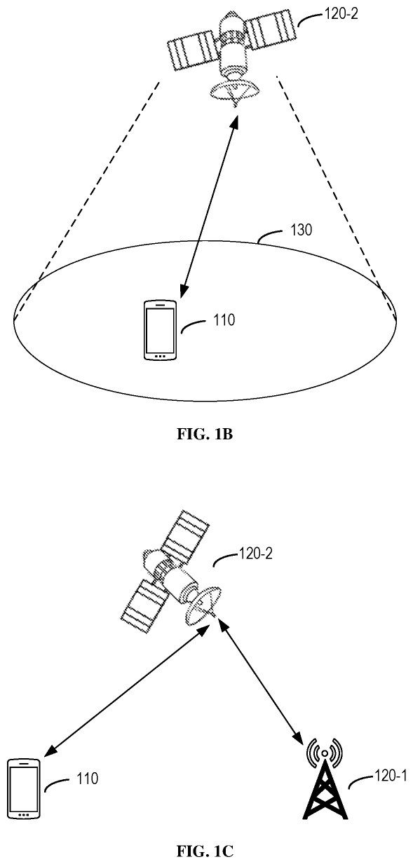

FIG. 1A illustrates an example of a network environment 100 in which some example embodiments of the present disclosure may be implemented. The network environment 100 may include a terminal device 110 and a network device 120. In some example embodiments, the environment 100 may be implemented as an NTN, and the network device 120 may include a communication satellite.

For example, as shown in FIG. 1B, the network device 120 includes the communication satellite 120-2, and the communication satellite 120-2 may operate as a gNB, or in other words, the gNB (on board) may locate in the communication satellite 120-2. As shown in FIG. 1B, the terminal device 110 may be located within a coverage 130 of the communication satellite 120-2, for example, the coverage 130 may be called as a NTN cell. Although it is not shown in FIG. 1B, the communication satellite 120-2 may communicate with a gateway device associated with a 5G core network (CN).

For example, as shown in FIG. 1C, the communication satellite 120-2 may operate as a passive or transparent network relay node between the terminal device 110 and a network device 120-1 on the ground. In some embodiments, the satellite 120-2 may communicate with the terminal device 110 via a service link or a wireless interface, and communicate with the network device 120-1 on the ground via a feeder link or a wireless interface.

In some embodiments, the satellite 120-2 may include a geosynchronous orbit (GEO) satellite, low earth orbit (LEO) satellite, or another type of satellite. In some embodiments, the satellite 120-2 may pertain to one or more satellite systems or architectures, such as a global navigation satellite system (GNSS), global positioning system (GPS), global navigation satellite system (GLONASS), BeiDou navigation satellite system (BDS), etc.

It is to be understood that the network environment 100 shown in FIG. 1A is only for the purpose of illustration without suggesting any limitation as to the scope of the disclosure. For example, while FIG. 1B or 1C depicts the terminal device 110 as a mobile phone, the terminal device 110 may be any type of user equipment.

For example, the network environment 100 may include a GNSS satellite, which may be used from GNSS measurement. In some embodiments, the GNSS satellite and the communication satellite may be different satellites. In some embodiments, the GNSS satellite and the communication satellite may be implemented as one satellite with two different functions.

Communications in the network environment 100 may be implemented according to any proper communication protocol(s), comprising, but not limited to, cellular communication protocols of the first generation (1G), the second generation (2G), the third generation (3G), the fourth generation (4G), the fifth generation (5G), and 6G, and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 110, the network device 120) and their connection relationships and types shown in FIG. 1A are only for the purpose of illustration without suggesting any limitation. The environment 100 may include any suitable numbers of devices adapted for implementing embodiments of the present disclosure.

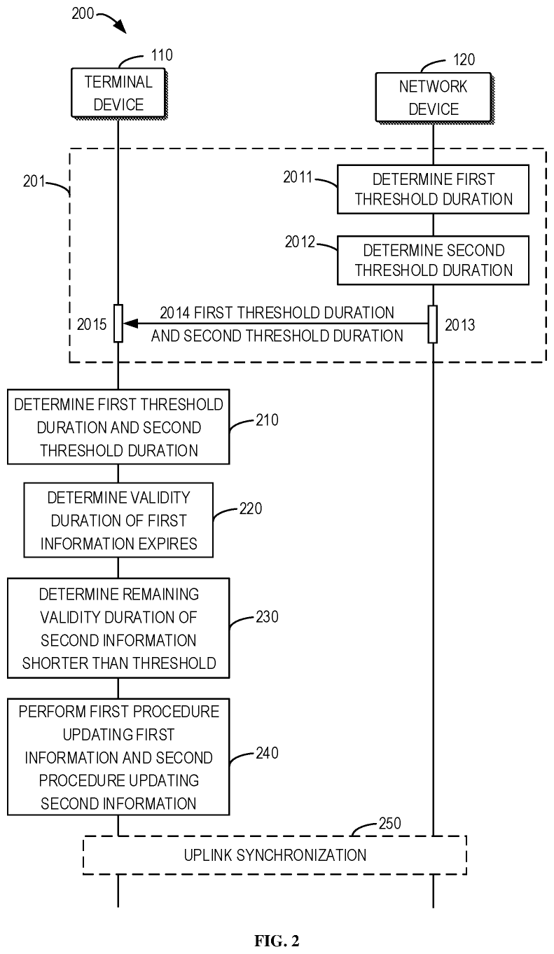

FIG. 2 illustrates an example of a process flow 200 in accordance with some example embodiments of the present disclosure. For the purpose of discussion, the process flow 200 will be described with reference to FIG. 1A. The process flow 200 involves a terminal device 110 and a network device 120. It would be appreciated that although the process flow 200 has been described in the network environment 100 of FIG. 1A, this process flow may be likewise applied to other communication scenarios.

In some example embodiments, the terminal device 110 may acquire GNSS position information by GNSS fix measurement. In some embodiments, the terminal device 110 may acquire ephemeris information by SIB reading. In some embodiments, the ephemeris information is for an LEO/GEO satellite which provides a cellular communication for the terminal device 110.

For ease of description, the process flow 200 is described by involving first information and second information, where the first information is GNSS position information and the second information is ephemeris information, or the first information is ephemeris information and the second information is GNSS position information. In some examples, for ease of description, the validity duration for the first information is denoted by T1, and the validity duration for the second information is denoted by T2. In some example embodiments, the process flow 200 may be performed during a DL/UL transmission of the terminal device 110, and the present disclosure does not limit this aspect.

In the process flow 200, the terminal device 110 determines 210 a first threshold duration for a remaining validity duration of first information and a second threshold duration for a remaining validity duration of second information. In some examples, for ease of description, the first threshold duration may be denoted as ΔT1, and the second threshold duration may be denoted as ΔT2. It is understood that ΔT1<T1 and ΔT2<T2.

In some example embodiments, as shown in FIG. 2, the process flow 200 may alternatively or in addition include an operation 201. In the operation 201, the network device 120 determines 2011 the first threshold duration for a remaining validity duration of the first information. The network device 120 determines 2012 the second threshold duration for a remaining validity duration of the second information.

In some embodiments, the network device 120 determines the first threshold duration based on one or more of: a required update frequency of the first information, an amount of data to be transmitted at the terminal device 110, history information of the first information, or a traffic pattern of a transmission to be performed by the terminal device 110. Similarly, the network device 120 determines the second threshold duration based on one or more of: a required update frequency of the second information, an amount of data to be transmitted at the terminal device 110, history information of the second information, or a traffic pattern of a transmission to be performed by the terminal device 110. For example, a threshold duration for ephemeris information may be based on a frequency of SIB, i.e., how often the SIB (such as SI19) is available. For example, a threshold duration for GNSS position information may be based on a frequency of the required GNSS, i.e., how often GNSS is required.

The network device 120 transmits 2013 the first threshold duration and the second threshold duration 2014 to the terminal device 110. In some examples, a radio resource control (RRC) message may be transmitted from the network device 120 to the terminal device 110, where the RRC message includes the first threshold duration and the second threshold duration 2014. On the other side of communication, the terminal device 120 receives 2015 the first threshold duration and the second threshold duration 2014. In some examples, the terminal device 120 may receive an RRC message from the network device 120, and obtain the first threshold duration and the second threshold duration 2014 from the RRC message. As such, the network device 120 may configure the first and second threshold durations for the first information and the second information respectively.

In some alternative example embodiments, the terminal device 110 may determine the first threshold duration and the second threshold duration based on pre-defined values. In some examples, there are a first pre-defined value corresponding to the first information and a second pre-defined value corresponding to the second information stored at the terminal device 110. In some examples, the terminal device 110 may determine that the first threshold duration equals to the first pre-defined value and the second threshold duration equals to the second pre-defined value.

In some embodiments, the first threshold duration (ΔT1) may be a coverage level based value or an elevation angle based value. Similarly, the second threshold duration (ΔT2) may be a coverage level based value or an elevation angle based value. Specifically, due to different path losses and the required repetition number for different elevation angles or different coverage levels, the first threshold duration (ΔT1) and/or the second threshold duration (ΔT2) may be an elevation angle-based value or a coverage level based value. For example, if the coverage level needs more repetition number, the first threshold duration (ΔT1) and/or the second threshold duration (ΔT2) may be a large value since the UL/DL transmission needs more time.

Continue to referring to FIG. 2, the terminal device 110 determines 220 that a validity duration of the first information expires. As described above, the validity duration for the first information may be denoted as T1, and the validity duration for the second information may be denoted as T2.

In some example embodiments, the terminal device 110 may start a first timer with a validity duration (T1) while acquiring the first information. In some examples, the terminal device 110 determines that the validity duration of the first information expires when the first timer reaches T1 (starts from 0) or reaches 0 (states from T1).

The terminal device 110 determines 230 that a remaining validity duration of the second information is shorter than the second threshold value. In some example embodiments, the terminal device 110 may start a second timer with a validity duration (T2) while obtaining the second information. In some examples, the terminal device 110 determines the remaining period of the second timer, and compares the remaining period of the second timer with the second threshold value (ΔT2).

In some example embodiment, the terminal device 110 may determine whether the remaining validity duration of the second information is shorter than the second threshold value. In some embodiments, if the remaining validity duration of the second information is shorter than the second threshold value, the terminal device 110 may further perform the operation 240 shown in FIG. 2. In some other embodiments, if the remaining validity duration of the second information is longer than or equals to the second threshold value, the terminal device 110 may perform a first procedure to update the first information.

In the process flow 200, the terminal device 110 performs 240 a first procedure updating the first information and a second procedure updating the second information. Specifically, if the validity duration of the first information expires and the remaining validity duration of the second information is shorter than the second threshold value, both the first procedure and the second procedure are performed.

It is understood that the first information and the second information may be exchangeable at operations 210-230. That is, the terminal device 110 may perform 240 the first procedure and the second procedure if the validity duration of the second information expires and the remaining validity duration of the first information is shorter than the first threshold value.

In some example embodiments, the order of the first procedure and the second procedure may be determined by the terminal device 110. For example, the order may be determined based on a first length of time for performing the first procedure and a second length of time for performing the second procedure. For example, the order may be up to UE implementation of the terminal device, due to the GNSS fix measurement needs more time and may different for hot start, warm start and cold start. For another example, the first procedure may be performed first since the validity duration of the first information expires.

In some embodiments, updated (or new) first information and updated (or new) second information may be re-acquired by the first procedure and the second procedure respectively. Alternatively or in addition, the terminal device 110 may further perform 250 the uplink synchronization based on the updated first information and the updated second information.

As stated above, the first information is GNSS position information and the second information is ephemeris information, or, the first information is ephemeris information and the second information is GNSS position information. According to the process 400, if the valid timer of GNSS position information (or ephemeris information) expires, and the remaining valid duration of ephemeris information (or GNSS position information) is shorter than a configured threshold duration, the terminal device 110 will perform both the GNSS fix measurement and ephemeris information reading, then re-acquire UL synchronization.

As such, the present disclosure proposes an inter-operation solution on GNSS fix measurement and ephemeris information reading to make the two procedures for UL synchronization are aligned with each other as possible, which can relax the limitation on the UL/DL transmission and scheduling as well as reduce the impact on UL/DL transmission and scheduling.

FIG. 3 illustrates an example timing graph 300 with GNSS information expiry in accordance with some example embodiments of the present disclosure. As an example, FIG. 3 shows an inter-work between the GNSS fix and the ephemeris information reading, in which expiration of the validity timer of the GNSS fix can trigger both the GNSS fix measurement and the ephemeris information reading. The threshold duration for GNSS fix may be denoted as Th_{GNSS}, and the threshold duration for ephemeris information may be denoted as Thₑₚₕₑₘₑᵣᵢₛ.

It is assumed that the GNSS fix measurement is performed at T01, and it is desired to be performed again at T31 based on the GNSS validity duration. It is assumed that the ephemeris information reading is performed at T11, and it is desired to be performed again at T21 based on the ephemeris validity duration. At T21, the ephemeris validity duration expires, since the remaining validity duration for the GNSS fix (T31−T21) is longer than the threshold Th_{GNSS}, thus the ephemeris information reading is performed without performing GNSS fix measurement at T21.

At T31, the GNSS validity duration expires, since the remaining validity duration for the ephemeris information (T51−T31) is shorter than the threshold Thₑₚₕₑₘₑᵣᵢₛ, thus the ephemeris information reading and the GNSS fix measurement are both performed. As such, the following issue may be avoided: the UL/DL data transmission cannot be scheduled or the repetition transmission cannot be finished before the ephemeris information expiration (T51). For example, as shown in FIG. 3, the GNSS fix measurement is performed at T31, following which the ephemeris information reading is performed at T41. Therefore, the ephemeris information reading may be triggered and performed at T41, and there is no need to perform the ephemeris information reading at T51.

In some embodiments, the terminal device 110 may start a GNSS validity timer at T01 and reset the GNSS validity timer at T31. In some embodiments, the terminal device 110 may start an ephemeris validity timer at T11, reset the ephemeris validity timer at T21, and reset the ephemeris validity timer again at T41. It is understandable that the remaining validity duration for the GNSS fix may be determined based on the GNSS validity timer, and the remaining validity duration for the ephemeris information may be determined based on the ephemeris validity timer. In addition, the uplink synchronization may be performed based on the new GNSS fix acquired at T31 and the new ephemeris information acquired at T41.

As a more specific example, as shown in FIG. 3, the terminal device (such as the UE) acquires GNSS position fix at T01 and starts the GNSS validity timer, then the UE gets the ephemeris information at T11 and T21. The GNSS validity time expires at T31, and the UE re-acquires the GNSS position fix at T31. After re-acquiring the GNSS fix, the UE will make further calculation on the remaining time of ephemeris information. If the remaining time is smaller than the configured threshold, which means the validity timer for ephemeris information will expire soon, to avoid the UL/DL data transmission cannot be scheduled or the repetition transmission cannot finished before the ephemeris information expiration, the ephemeris information reading can be triggered after the GNSS fix measurement, e.g., at T41. And the UE will perform UL synchronization with the new GNSS fix and ephemeris information. If the remaining time is larger than the configured threshold, which means the UL/DL data can be scheduled and transmitted in this period, there is no need to trigger the ephemeris information reading.

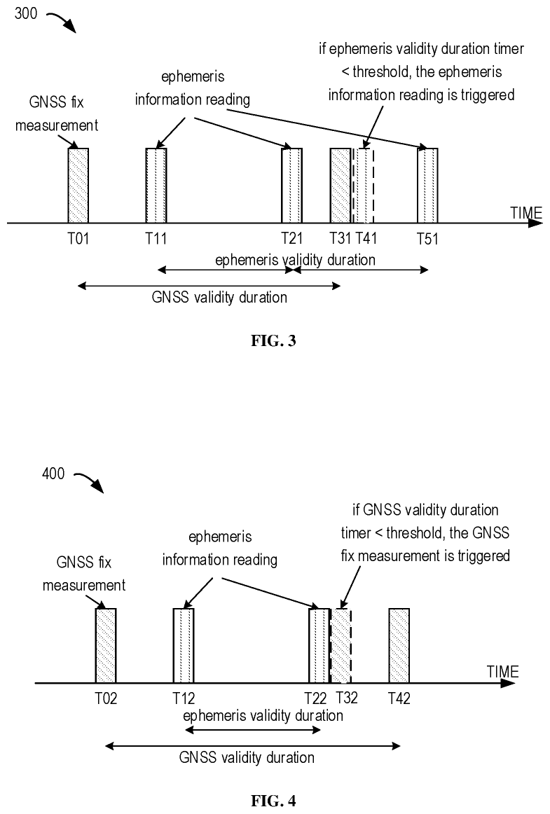

FIG. 4 illustrates an example of timing graph 400 with ephemeris information expiry in accordance with some example embodiments of the present disclosure. As an example, FIG. 4 shows an inter-work between GNSS fix and ephemeris information reading, in which expiration of the validity timer of the ephemeris information can trigger both the GNSS fix measurement and the ephemeris information reading. The threshold duration for GNSS fix may be denoted as Th_{GNSS}, and the threshold duration for ephemeris information may be denoted as Thₑₚₕₑₘₑᵣᵢₛ.

It is assumed that the GNSS fix measurement is performed at T02, and it is desired to be performed again at T42 based on the GNSS validity duration. It is assumed that the ephemeris information reading is performed at T12, and it is desired to be performed again at T22 based on the ephemeris validity duration.

At T22, the ephemeris validity duration expires, since the remaining validity duration for the GNSS fix (T42−T22) is shorter than the threshold Th_{GNSS}, thus the ephemeris information reading and the GNSS fix measurement are both performed. As such, the following issue may be avoided: the UL/DL data transmission cannot be scheduled or the repetition transmission cannot be finished before the GNSS fix information expiration (T42). For example, as shown in FIG. 4, the ephemeris information reading is performed at T22, following which the GNSS fix measurement is performed at T32. Therefore, the GNSS fix measurement may be triggered and performed at T32, and there is no need to perform the GNSS fix measurement at T42.

In some embodiments, the terminal device 110 may start a GNSS validity timer at T02 and reset the GNSS validity timer at T32. In some embodiments, the terminal device 110 may start an ephemeris validity timer at T12, and reset the ephemeris validity timer at T22. It is understandable that the remaining validity duration for the GNSS fix may be determined based on the GNSS validity timer.

As a more specific example, as shown in FIG. 4, if the validity time for ephemeris information is expired, e.g., at T22, the terminal device (such as the UE) will make further calculation on the remaining time of GNSS fix. If the remaining time is smaller than the configured threshold, which means the validity time for GNSS will expire soon, to avoid the UL/DL data transmission cannot be scheduled or the repetition transmission cannot finished before the new GNSS fix re-acquisition, the GNSS fix measurement can be triggered, due to the GNSS fix measurement need more time and are different for hot start, warm start and cold start, the order to perform GNSS fix measurement and ephemeris information reading may be up to UE implementation. The UE will perform UL synchronization with the new GNSS fix and ephemeris information. If the remaining time is larger than the configured threshold, which means the UL/DL data can be scheduled and transmitted in this period, there is no need to trigger the GNSS fix measurement.

In addition, the uplink synchronization may be performed based on the new ephemeris information acquired at T22 and the new GNSS fix acquired at T32. It is to be understood the example usages shown in FIGS. 3-4 are only for illustration without suggesting any limitation as to the scope of the disclosure. For example, in some other examples, the GNSS validity duration may be shorter than or equal to the ephemeris validity duration, and the present disclosure does not limit this aspect.

Therefore, the terminal device 110 may re-acquire the updated GNSS position information and updated ephemeris information in a coordinated manner. It is understood that the technical solution in the present disclosure may solve an issue due to differences in configurations of GNSS fix measurement and ephemeris information reading. As such, the present disclosure provides an optimized solution on GNSS fix measurement and ephemeris information reading for UL synchronization supporting long connection times and power consumption reduction. Specifically, only one gap is needed for updating GNSS position information and ephemeris information, and thus the solution may simplify network design and UE implementation, as well as reduce the impact on UL/DL transmission and scheduling.

Combination of two procedures to make use of a single measurement gap instead of two. This is more efficient when it comes to scheduling and network operation. The inter-operation solution on GNSS fix and ephemeris information reading can make the two procedures for UL synchronization are aligned with each other as possible. In some embodiments, the network can configure two thresholds for the valid duration of GNSS fix and ephemeris information separately. Alternatively, the thresholds can be pre-defined in UE.

Based on the description above, an inter-operation solution on GNSS fix and ephemeris information reading can make the two procedures for UL synchronization are aligned with each other as possible. The terminal device can perform UL synchronization with the new GNSS fix and ephemeris information together. If the GNSS fix measurement and ephemeris information reading are re-acquired at different times and the time interval is very close, the UL/DL transmission can't be scheduled and transmitted in this interval due to the long time needed for repetition transmission. The solution proposed in the present disclosure can relax the limitation on the UL/DL transmission and scheduling as well as reduce the impact on UL/DL transmission and scheduling.

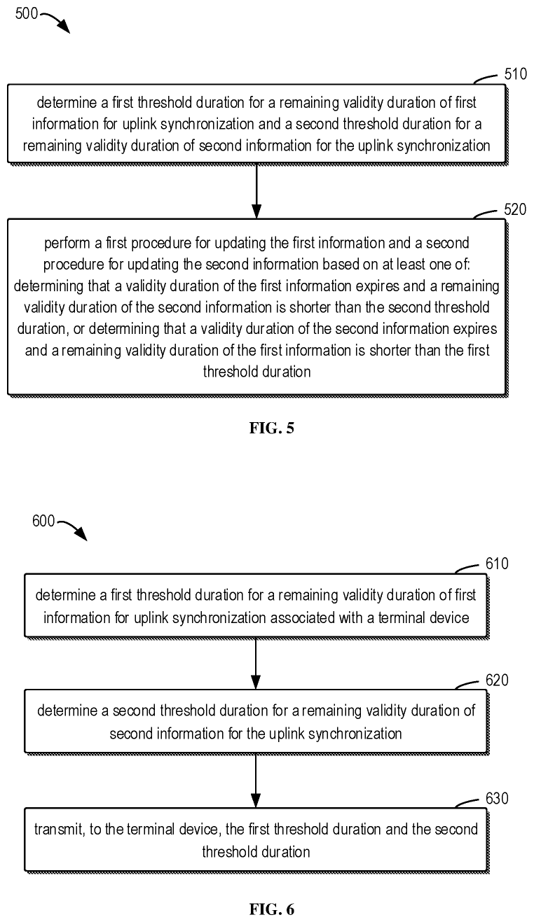

FIG. 5 illustrates a flowchart 500 of a method implemented at a terminal device in accordance with some example embodiments of the present disclosure. For the purpose of discussion, the method 500 will be described from the perspective of the terminal device 110 with reference to FIG. 1A.

At block 510, the terminal device 110 determines a first threshold duration for a remaining validity duration of first information for uplink synchronization and a second threshold duration for a remaining validity duration of second information for the uplink synchronization. At block 520, the terminal device 110 performs a first procedure for updating the first information and a second procedure for updating the second information based on at least one of: determining that a validity duration of the first information expires and a remaining validity duration of the second information is shorter than the second threshold duration, or determining that a validity duration of the second information expires and a remaining validity duration of the first information is shorter than the first threshold duration.

In some example embodiments, the terminal device 110 determines the first threshold duration based on a first predefined value corresponding to the first information; and determines the second threshold duration based on a second predefined value corresponding to the second information.

In some example embodiments, the terminal device 110 receives, from a network device 120, the first threshold duration and the second threshold duration.

In some example embodiments, the terminal device 110 receives, from the network device 120, a radio resource control (RRC) message comprising the first threshold duration and the second threshold duration.

In some example embodiments, the first threshold duration comprises at least one of: a coverage level based value, or an elevation angle based value. In some example embodiments, the second threshold duration comprises at least one of: a coverage level based value, or an elevation angle based value.

In some example embodiments, the terminal device 110 determines an order to perform the first procedure and the second procedure, based on a first length of time for performing the first procedure and a second length of time for performing the second procedure.

In some example embodiments, the terminal device 110 performs the uplink synchronization based on updated first information and updated second information.

In some example embodiments, the first information comprises global navigation satellite system (GNSS) position information and the second information comprises ephemeris information. In some example embodiments, the first information comprises the ephemeris information and the second information comprises the GNSS position information.

In some example embodiments, the terminal device 110 performs the first procedure without performing the second procedure if a validity duration of the first information expires and a remaining validity duration of the second information is longer than the second threshold duration; or the terminal device 110 performs the second procedure without performing the first procedure if a validity duration of the second information expires and a remaining validity duration of the first information is longer than the first threshold duration.

FIG. 6 illustrates a flowchart 600 of a method implemented at a network device in accordance with some example embodiments of the present disclosure. For the purpose of discussion, the method 600 will be described from the perspective of the network device 120 with reference to FIG. 1A.

At block 610, the network device 120 determines a first threshold duration for a remaining validity duration of first information for uplink synchronization associated with a terminal device. At block 620, the network device 120 determines a second threshold duration for a remaining validity duration of second information for the uplink synchronization. At block 630, the network device 120 transmits, to the terminal device 110, the first threshold duration and the second threshold duration.

In some example embodiments, the network device 120 transmits, to the terminal device 110, a radio resource control (RRC) message comprising the first threshold duration and the second threshold duration.

In some example embodiments, the first threshold duration comprises at least one of: a coverage level based value, or an elevation angle based value. In some example embodiments, the second threshold duration comprises at least one of: a coverage level based value, or an elevation angle based value.

In some example embodiments, the first information comprises global navigation satellite system (GNSS) position information and the second information comprises ephemeris information. In some example embodiments, the first information comprises the ephemeris information and the second information comprises the GNSS position information.

In some example embodiments, an apparatus capable of performing the method 500 (for example, the terminal device 110) may comprise means for performing the respective steps of the method 500. The means may be implemented in any suitable form. For example, the means may be implemented in a circuitry or software module.

In some example embodiments, the apparatus comprises: means for determining, at a terminal device, a first threshold duration for a remaining validity duration of first information for uplink synchronization and a second threshold duration for a remaining validity duration of second information for the uplink synchronization; and means for performing a first procedure for updating the first information and a second procedure for updating the second information based on at least one of: determining that a validity duration of the first information expires and a remaining validity duration of the second information is shorter than the second threshold duration, or determining that a validity duration of the second information expires and a remaining validity duration of the first information is shorter than the first threshold duration.

In some example embodiments, the means for determining the first threshold duration and the second threshold duration comprises: means for determining the first threshold duration based on a first predefined value corresponding to the first information; and means for determining the second threshold duration based on a second predefined value corresponding to the second information.

In some example embodiments, the means for determining the first threshold duration and the second threshold duration comprises: means for receiving, from a network device, the first threshold duration and the second threshold duration.

In some example embodiments, the means for receiving the first threshold duration and the second threshold duration comprises: means for receiving, from the network device, a radio resource control (RRC) message comprising the first threshold duration and the second threshold duration.

In some example embodiments, the first threshold duration comprises at least one of: a coverage level based value, or an elevation angle based value. In some example embodiments, the second threshold duration comprises at least one of: a coverage level based value, or an elevation angle based value.

In some example embodiments, the apparatus further comprises: means for determining an order to perform the first procedure and the second procedure, based on a first length of time for performing the first procedure and a second length of time for performing the second procedure.

In some example embodiments, the apparatus further comprises: means for performing the uplink synchronization based on updated first information and updated second information.

In some example embodiments, the first information comprises global navigation satellite system (GNSS) position information and the second information comprises ephemeris information. In some example embodiments, the first information comprises the ephemeris information and the second information comprises the GNSS position information.

In some example embodiments, the apparatus further comprises: means for performing the first procedure without performing the second procedure if a validity duration of the first information expires and a remaining validity duration of the second information is longer than the second threshold duration; or means for performing the second procedure without performing the first procedure if a validity duration of the second information expires and a remaining validity duration of the first information is longer than the first threshold duration.

In some example embodiments, the apparatus further comprises means for performing other steps in some example embodiments of the method 500. In some example embodiments, the means comprises at least one processor; and at least one memory including computer program code, the at least one memory and computer program code configured to, with the at least one processor, cause the performance of the apparatus.

In some example embodiments, an apparatus capable of performing the method 600 (for example, the network device 120) may comprise means for performing the respective steps of the method 860. The means may be implemented in any suitable form. For example, the means may be implemented in a circuitry or software module.

In some example embodiments, the apparatus comprises: means for determining, at a network device, a first threshold duration for a remaining validity duration of first information for uplink synchronization associated with a terminal device; means for determining a second threshold duration for a remaining validity duration of second information for the uplink synchronization; and means for transmitting, to the terminal device, the first threshold duration and the second threshold duration.

In some example embodiments, the means for transmitting the first threshold duration and the second threshold duration comprises: means for transmitting, to the terminal device 110, a radio resource control (RRC) message comprising the first threshold duration and the second threshold duration.

In some example embodiments, the first threshold duration comprises at least one of: a coverage level based value, or an elevation angle based value. In some example embodiments, the second threshold duration comprises at least one of: a coverage level based value, or an elevation angle based value.

In some example embodiments, the first information comprises global navigation satellite system (GNSS) position information and the second information comprises ephemeris information. In some example embodiments, the first information comprises the ephemeris information and the second information comprises the GNSS position information.

In some example embodiments, the apparatus further comprises means for performing other steps in some example embodiments of the method 600. In some example embodiments, the means comprises at least one processor; and at least one memory including computer program code, the at least one memory and computer program code configured to, with the at least one processor, cause the performance of the apparatus.

The solution reduces potentially needed scheduling gaps, hence it improves the network capacity. The threshold values could in principle be derived in the UE, based on knowledge about how often GNSS fix required, how often the SIB is available, how much data is to be transmitted in UL. Hence the mechanism could be working in the UE without any network control or knowledge. However, in the proposed solution, with network control on setting the threshold values, the scheduling gaps are more predictable, and both DL and UL traffic patterns of the UE can be accommodated. The UE can also determine its own threshold values from ‘past experience’ and expected DL/UL traffic pattern. The present disclosure is new and especially when it comes to signalling of the thresholds for the validity durations of GNSS fix and ephemeris information in a single message and working with RRC signalling.

There are some key features of the present disclosure: (a) The network can configure two thresholds for the remaining valid duration of GNSS fix and ephemeris information separately. Alternatively, the thresholds can be pre-defined in UE. (b) If the valid timer of GNSS fix (or ephemeris information) expires, and the remaining valid duration of ephemeris information (or GNSS fix) is smaller than the configured threshold, the UE will perform both the GNSS fix measurement and ephemeris information reading, then re-acquire UL synchronization. (c) If the remaining time is smaller than the configured threshold, which means the validity timer for ephemeris information will expire soon, before the ephemeris information expiration the ephemeris information reading can be triggered after the GNSS fix measurement. (d) The UE will perform UL synchronization with the new GNSS fix and ephemeris information. If the remaining time is larger than the configured threshold, which means the UL/DL data can be scheduled and transmitted in this period, it is no need to trigger the ephemeris information reading. (e) The UE will make further calculation on the remaining time of GNSS fix, before the GNSS fix re-acquisition, the GNSS fix measurement can be triggered. (f) Due to the GNSS fix measurement need more time and are different for hot start, warm start and cold start, the order to perform GNSS fix measurement and ephemeris information reading is up to UE implementation. (g) The UE will perform UL synchronization with the new GNSS fix and ephemeris information. If the remaining time is larger than the configured threshold, which means the UL/DL data can be scheduled and transmitted in this period, it is no need to trigger the GNSS fix measurement.

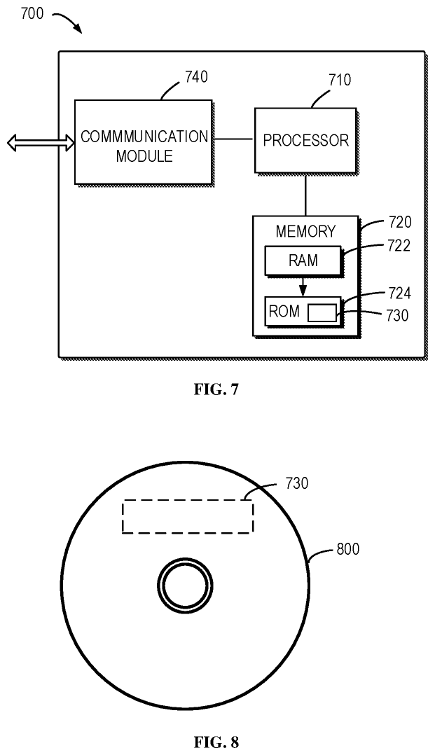

FIG. 7 illustrates a simplified block diagram of a device 700 that is suitable for implementing some example embodiments of the present disclosure. The device 700 may be provided to implement the communication device, for example the terminal device 110, or the network device 120 as shown in FIG. 1A. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2-6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor; and
at least one memory storing instructions that, when executed by the at least one processor, cause the terminal device at least to:
determine a first threshold duration for a remaining validity duration of first information for uplink synchronization and a second threshold duration for a remaining validity duration of second information for the uplink synchronization; and
perform a first procedure for updating the first information and a second procedure for updating the second information based on at least one of:
determining that a validity duration of the first information expires and a remaining validity duration of the second information is shorter than the second threshold duration, or
determining that a validity duration of the second information expires and a remaining validity duration of the first information is shorter than the first threshold duration.

2. The terminal device of claim 1, wherein the terminal device is caused to determine the first threshold duration and the second threshold duration by:
determining the first threshold duration based on a first predefined value corresponding to the first information; and
determining the second threshold duration based on a second predefined value corresponding to the second information.

3. The terminal device of claim 1, wherein the terminal device is caused to determine the first threshold duration and the second threshold duration by:
receive, from a network device, the first threshold duration and the second threshold duration.

4. The terminal device of claim 3, wherein the terminal device is caused to receive the first threshold duration and the second threshold duration by:
receiving, from the network device, a radio resource control (RRC) message comprising the first threshold duration and the second threshold duration.

5. The terminal device of any of claims 1-4, wherein at least one of the first threshold duration or the second threshold duration comprises at least one of:
a coverage level based value, or
an elevation angle based value.

6. The terminal device of any of claims 1-5, wherein the terminal device is further caused to:
determine an order to perform the first procedure and the second procedure, based on a first length of time for performing the first procedure and a second length of time for performing the second procedure.

7. The terminal device of any of claims 1-6, wherein the terminal device is further caused to:
perform the uplink synchronization based on updated first information and updated second information.

8. The terminal device of any of claims 1-7, wherein:
the first information comprises global navigation satellite system (GNSS) position information and the second information comprises ephemeris information, or
the first information comprises the ephemeris information and the second information comprises the GNSS position information.

9. The terminal device of any of claims 1-8, wherein the terminal device is further caused to:
based on determining that a validity duration of the first information expires and a remaining validity duration of the second information is longer than the second threshold duration, perform the first procedure without performing the second procedure; or
based on determining that a validity duration of the second information expires and a remaining validity duration of the first information is longer than the first threshold duration, perform the second procedure without performing the first procedure.

10. A network device comprising:
at least one processor; and
at least one memory storing instructions that, when executed by the at least one processor, cause the network device at least to:
determine a first threshold duration for a remaining validity duration of first information for uplink synchronization associated with a terminal device;
determine a second threshold duration for a remaining validity duration of second information for the uplink synchronization; and
transmit, to the terminal device, the first threshold duration and the second threshold duration.

11. The network device of claim 10, wherein the network device is caused to transmit the first threshold duration and the second threshold duration by:
transmitting, to the terminal device, a radio resource control (RRC) message comprising the first threshold duration and the second threshold duration.

12. The network device of claim 10 or 11, wherein at least one of the first threshold duration or the second threshold duration comprises at least one of:
an elevation angle based value, or
a coverage level based value.

13. The network device of any of claims 10-12, wherein:
the first information comprises global navigation satellite system (GNSS) position information and the second information comprises ephemeris information, or
the first information comprises the ephemeris information and the second information comprises the GNSS position information.

14. A method comprising:
determining, at a terminal device, a first threshold duration for a remaining validity duration of first information for uplink synchronization and a second threshold duration for a remaining validity duration of second information for the uplink synchronization; and
performing a first procedure for updating the first information and a second procedure for updating the second information based on at least one of:
determining that a validity duration of the first information expires and a remaining validity duration of the second information is shorter than the second threshold duration, or
determining that a validity duration of the second information expires and a remaining validity duration of the first information is shorter than the first threshold duration.

15. A method comprising:
determining, at a network device, a first threshold duration for a remaining validity duration of first information for uplink synchronization associated with a terminal device;
determining a second threshold duration for a remaining validity duration of second information for the uplink synchronization; and
transmitting, to the terminal device, the first threshold duration and the second threshold duration.

16. An apparatus comprising:
means for determining, at a terminal device, a first threshold duration for a remaining validity duration of first information for uplink synchronization and a second threshold duration for a remaining validity duration of second information for the uplink synchronization; and
means for performing a first procedure for updating the first information and a second procedure for updating the second information based on at least one of:
determining that a validity duration of the first information expires and a remaining validity duration of the second information is shorter than the second threshold duration, or
determining that a validity duration of the second information expires and a remaining validity duration of the first information is shorter than the first threshold duration.

17. An apparatus comprising:
means for determining, at a network device, a first threshold duration for a remaining validity duration of first information for uplink synchronization associated with a terminal device;
means for determining a second threshold duration for a remaining validity duration of second information for the uplink synchronization; and
means for transmitting, to the terminal device, the first threshold duration and the second threshold duration.

18. A non-transitory computer readable medium comprising program instructions stored thereon for performing at least the method of any of claims 14-15.
